(19) United States
(12) Patent Application Publication
(10) Pub. No.: US 2024/0289607 A1
(43) Pub. Date: Aug. 29, 2024

(54) CO-DESIGN OF A MODEL AND CHIP FOR DEEP LEARNING BACKGROUND

(71) Applicant: International Business Machines Corporation, Armonk, NY (US)

(72) Inventors: Irem Boybat Kara, Adliswil (CH); Hadjer Benmeziane, AULNOY-LEZ-VALENCIENNES (FR); Manuel Le Gallo-Bourdeau, Horgen (CH); Kaoutar El Maghraoui, Yorktown Heights, NY (US); Malte Johannes Rasch, Chappaqua, NY (US); HsinYu Tsai, Cupertino, CA (US)

(21) Appl. No.: 18/174,694

(22) Filed: Feb. 27, 2023

(51) Int. Cl. G06N 3/08

(52) U.S. Cl. CPC G06N 3/08

(57) ABSTRACT

A method, computer program product, and system to generate a processor design via a deep neural network is provided. A processor selects an architecture search space and a hardware components space. A processor selects an initial deep neural network from the architecture search space. A processor determines an initial current chip design for executing the current deep neural network, wherein the initial chip design has a hardware performance metric for implementing the current deep neural network. A processor repeatedly executes an optimization method, the optimization method comprising modifying the chip design one or more times using components from the hardware components space and optimizing the current deep neural network by selecting a deep neural network from the architecture search space. A processor provides the optimized chip design and the specific deep neural network for performing the machine learning task.

### BACKGROUND OF THE INVENTION

The present invention relates generally to the field of digital computer systems, and more specifically, to a method for performing a machine learning task.

Current artificial intelligence (AI) accelerators may be inefficient to high number of tasks as each machine learning (ML) task may require a specific deep neural network. To solve this, the placement and connectivity of their components may be adapted to increase their efficiency to these tasks. However, there is a need to improve this adaptation process.

### SUMMARY

Embodiments of the present invention provide a method, system, and program product to generate a processor design via a deep neural network. A processor selects an architecture search space and a hardware components space, wherein the architecture search space comprises architectures and the hardware components space comprising components for executing a deep neural network. A processor selects an initial deep neural network from the architecture search space. A processor determines an initial current chip design for executing the current deep neural network, wherein the initial chip design has a hardware performance metric for implementing the current deep neural network. A processor repeatedly executes an optimization method, the optimization method comprising: a first optimizer optimizing the current chip design by modifying the chip design one or more times using components from the hardware components space, the optimization being performed in order to improve the hardware performance metric of the current chip design, the optimization resulting in a chip design which is the current chip design for a next repetition; and a second optimizer optimizing the current deep neural network by selecting a deep neural network from the architecture search space, the optimization being performed in order to improve the machine learning task performance metric of the current deep neural network, the optimization resulting in a deep neural network which is the current deep neural network for a next repetition, wherein the optimization method is repeated until a combination of the hardware performance metric and the machine learning task performance metric that is obtained for a specific deep neural network fulfills a convergence criterion. A processor provides the optimized chip design and the specific deep neural network for performing the machine learning task.

### BRIEF DESCRIPTION OF THE SEVERAL VIEWS OF THE DRAWINGS

FIG. 1 is a flowchart of a first method for performing a machine learning task in accordance with an example of the present subject matter.

FIG. 2 is a flowchart of a second method for performing a machine learning task in accordance with an example of the present subject matter.

FIG. 3 is a flowchart of a third method for performing a machine learning task in accordance with an example of the present subject matter.

FIG. 4 is a flowchart of a fourth method for performing a machine learning task in accordance with an example of the present subject matter.

FIG. 5 is a flowchart of a first method for performing a second optimization step in accordance with an example of the present subject matter.

FIG. 6 is a flowchart of a second method for performing a second optimization step in accordance with an example of the present subject matter.

FIG. 7 is a flowchart of a method for performing a first optimization step in accordance with an example of the present subject matter.

FIGS. 8A-D are diagrams illustrating a method for performing an optimization in accordance with an example of the present subject matter.

FIG. 9 is a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Deep neural networks can be used to perform different machine learning tasks. The machine learning task refers to a type of inference being made based on a predefined problem and an available dataset. Embodiments of the present invention enable the ability to perform a machine learning task. The machine learning task can, for example, be a classification task, a regression task, an object detection task, a language modelling task or any task that can be learned and performed by a deep neural network. The present subject matter enables to execute the machine learning task on a system by looking concurrently at the hardware and software aspects of the system. In particular, the hardware and software aspects are developed together and intertwined for an optimal execution of the machine learning task. For that, an architecture search space and a hardware components space are be provided.

The architecture search space is a vector space that is defined by a set of parameters (SPARₛₑₜ). The set of parameters SPARₛₑₜ describe the topologies of the deep neural networks and features of the deep neural network. The set of parameters SPARₛₑₜ comprise hyperparameters of the deep neural network and topology parameters of the deep neural network. The topology parameters, for example, comprise number of layers, types of operations, connections between operations etc. The hyperparameters, for example, describe the features of operations of the deep neural network and features of the learning process. The hyperparameters, for example, comprise filter sizes for convolution operations, learning rate schedules, dropout rates of the learning process etc. The architecture search space comprises multiple states or points, wherein each state is defined by specific values of the set of parameters SPARₛₑₜ. The architecture search space can be associated with operators that provide a mechanism to move from one state to another state. For example, a first deep neural network (first state) has a first set of values of the set of parameters SPARₛₑₜ. By varying one or more values of the first set of values, a second deep neural network (second state) may be obtained from the first deep neural network. The present subject matter may make use of the architecture search space for automatically designing deep neural networks.

The architecture search space represents a set of deep neural network architectures, where the computer system jointly searches for the best architecture within the space as well as an optimized chip placement design. The set of architectures contains a single type of architectures such as transformers, convolutional neural network, and recurrent neural network or a hybrid set containing different types of neural networks.

A deep neural network (DNN) using the architecture search space in order to perform the machine learning task is provided. The deep neural network DNN is a supervised trained deep neural network. For example, the deep neural network DNN is obtained by selecting a specific point of the architecture search space. The obtained deep neural network DNN is evaluated using a machine learning task performance metric (MLPM). The evaluation can be performed by executing (e.g., by the computer system) the deep neural network DNN. This evaluation is performed using a dataset that is associated with the machine learning task. Alternatively, the machine learning task performance metric MLPM of the deep neural network DNN is predicted e.g., using historical data descriptive of neural networks and associated performances.

The machine learning task performance metric MLPM may be dependent on the type of the machine learning task. In one example, the machine learning task performance metric (MLPM) may be at least one of: accuracy, precision, recall, blue score, Peak signal-to-noise ratio (PSNR), F1 score, mean squared error, root mean squared error, mean absolute error and any other metric that can quantify the performance of a deep neural network. That is, the machine learning task performance metric MLPM may be provided as a single value or as a vector/tuple of values. For example, in case the machine learning task performance metric MLPM is the accuracy (ACC) and the precision (PREC), the value of the machine learning task performance metric MLPM may be represented by a vector having two entries [ACC, PREC]. In case the machine learning task performance metric MLPM is the accuracy, the value of the machine learning task performance metric may be represented by a scalar ACC etc. The accuracy, precision and recall may be used for classification tasks. The classification may for example be a binary classification of an input sample into one of two classes: positive and negative. The accuracy may, for example, be defined as the ratio between the number of correct predictions of the deep neural network DNN to the total number of predictions. The precision may, for example, be the ratio between the number of positive samples correctly classified to the total number of samples classified as positive. The recall may, for example, be the ratio between the number of positive samples correctly classified as positive to the total number of positive samples. The mean squared error, root mean squared error, and mean absolute error may be used for regression tasks.

The deep neural network DNN obtained from the architecture search space is associated with a set of values of the set of parameters SPARₛₑₜ. This set of values are descriptive of a sequence of operations of the deep neural network DNN and descriptive of the topology of the deep neural network DNN. Each operation of the operations may, for example, be described by an input, a type of computation on the input, an output of the operation and dependencies with other operations. This set of values may advantageously be used in accordance with the present subject matter in order to automatically define a chip design that can execute the deep neural network DNN. For that, the hardware components space may be used.

The hardware components space comprises at least one vector space that is defined by a set of hardware parameters (HPARₛₑₜ). For example, the hardware components space may comprise a vector space per distinct type of hardware components e.g., one vector space for processing elements, one vector space for memories etc. In his case, each vector space may be defined by a subset of the set of hardware parameters HPARₛₑₜ of the respective type of hardware components. This may be advantageous as it may enable an individualized control of the selection process. Alternatively, the hardware components space may comprise one vector space defined by the set of hardware parameters HPARₛₑₜ. This may be advantageous as it may enable a simplified and time saving selection of chip designs. The set of hardware parameters HPARₛₑₜ may indicate types of hardware components and their properties. The set of hardware parameters HPARₛₑₜ may, for example, comprise the number of processing elements, the number of compute lanes per processing element, multiply-and-accumulate (MAC) circuits, the memory sizes of local and global memories, the input/output (I/O) bandwidth, pipelining and coordination among these elements etc. The hardware components space may be used to define architectures that may be used for physically executing the deep neural network DNN in circuitry with different memory and processing elements.

A chip design (Chip) to execute the deep neural network DNN is obtained using the hardware components space. The chip design Chip refers to the layout and structure of the chip components and their interconnections. The obtained chip design Chip is evaluated using a hardware performance metric (HWPM). The evaluation of the chip design Chip may, for example, be performed using a simulation software that models the chip design Chip and the execution of the deep neural network DNN by the chip design Chip. Alternatively, the evaluation of the chip design Chip may be predicted e.g., using historical data descriptive of chip designs for neural networks and associated performances or using analytical models.

In one example, the hardware performance metric HWPM may comprise at least one of: number of components in the chip design, area occupied by the components, energy required for executing the deep neural network and time of execution of the deep neural network by the chip design. That is, the hardware performance metric HWPM may be provided as a single value or as a vector/tuple of values. For example, in case the hardware performance metric HWPM is the energy (E), the area (A) and the latency (L), the value of the hardware performance metric may be represented by a vector having three entries [E, A, L]. In case the hardware performance metric HWPM is the energy, the value of the hardware performance metric may be represented by a scalar E etc. The latency may refer to the time required by the chip design to execute the deep neural network.

The hardware components space and the architecture search space as described above are used by the present invention for an efficient execution of a desired machine learning task. In particular, the present subject matter automatically identifies both an optimal chip design and an optimal deep neural network for performing the desired machine learning task. For that, the present subject matter uses an initialization method followed by a repeated execution of an optimization method in order to co-design a deep neural network and corresponding chip design for executing the desired machine learning task. The repeated execution of the optimization method is referred to as “iterative process”.

The initialization method comprises the selection from the architecture search space of an initial deep neural network (DNN₁) for the desired machine learning task and usage of the hardware components space for the determination of an initial chip design (Chip₁) for executing the initial deep neural network DNN₁. The initial deep neural network DNN₁ may, for example, be evaluated (e.g., as described above) in order to determine a value (MLPM₁) of the machine learning task performance metric. Additionally, the hardware performance metric may be evaluated (e.g., as described above) for the initial chip design Chip₁ to obtain a value (HWPM₁) of the hardware performance metric.

In one example, the initial chip design Chip₁ may be built using a single component that is automatically obtained from the hardware components space. This single component may execute at least part of the deep neural network DNN₁ e.g., the single component may execute the whole deep neural network DNN₁ or part of the deep neural network DNN₁. In the latter case, one or more iterations may be performed in order to provide the initial chip design Chip₁ that can execute the whole deep neural network DNN₁. This example may be advantageous as it may enable a simplified and automatic initialization of the chip design. Alternatively, the initial chip design Chip₁ may be a user defined chip design that can execute the deep neural network DNN₁. A user defined chip design may enable a faster convergence of the iterative process because the chip design defined by a user may be closer to an optimal chip design.

The optimization method can be executed using an input. The input may be obtained as a result/output of an execution of the initialization method or as a result of a previous execution or iteration of the optimization method. The input may, for example, comprise a deep neural network DNNᵢ, the value MLPMᵢ of the machine learning task performance metric of the deep neural network DNNᵢ, a chip design Chipᵢ, and the value HWPMᵢ of the hardware performance metric of the chip design Chipᵢ, where i is an index that represents the i^{th} execution of the optimization method, where e.g., i=1, for the first execution of the optimization method, i=2, for the second execution of the optimization method, i=3, for the third execution of the optimization method and so on.

The optimization method comprises a first optimization step and a second optimization step. The first optimization step and second optimization step may be performed by a first optimizer and a second optimizer respectively. The first optimization step of a current i^{th} execution of the optimization method optimizes, using the hardware components space, the current chip design Chipᵢ for execution of the current deep neural network DNNᵢ, wherein the optimization is performed to improve the current value HWPMᵢ of the hardware performance metric of the current chip design Chipᵢ. The first optimization step of the current i^{th} execution of the optimization method results in a new chip design Chipᵢ₊₁ having a value HWPMᵢ₊₁ of the hardware performance metric, where the metric value HWPMᵢ₊₁ is better than the metric value HWPMᵢ. The second optimization step of a current i^{th} execution of the optimization method optimizes, using the architecture search space, the current deep neural network DNNᵢ in order to improve the current value MLPMᵢ of the machine learning task performance metric of the current deep neural network DNNᵢ. The second optimization step for the i^{th} execution results in a new deep neural network DNNᵢ₊₁ having a value MLPMᵢ₊₁ of the machine learning task performance metric, where the metric value MLPMᵢ₊₁ is better than the metric value MLPMᵢ.

A comparison method is performed in order to determine which of two metric values is better. For example, the value HWPMᵢ₊₁ of the hardware performance metric may be compared against the other value HWPMᵢ of the hardware performance metric in order to determine which of the two values is better than the other. For example, if the value of the hardware performance metric is represented by a scalar, metric value HWPMᵢ₊₁ may be better than metric value HWPMᵢ if metric value HWPMᵢ₊₁ exceeds (e.g., higher than) metric value HWPMᵢ. If the value of the hardware performance metric is represented by a vector, metric value HWPMᵢ₊₁ may be better than metric value HWPMᵢ, if every entry of the vector representing HWPMᵢ₊₁ is better than the respective entry of the vector representing HWPMᵢ. This comparison may provide robust and accurate predictions. Alternatively, metric value HWPMᵢ₊₁ may be better than metric value HWPMᵢ if a minimum number of entries (e.g., more than 50%) of the vector representing HWPMᵢ₊₁ are better than the respective entries of the vector representing HWPMᵢ. This comparison may similarly be applied for comparing the values of the machine learning task performance metric.

The optimization method is repeated until a combination of the hardware performance metric HWPMᵢ (of chip design Chipᵢ) and the machine learning task performance metric MLPMᵢ₋₁ that is obtained for a specific deep neural network DNNᵢ₋₁ fulfills a convergence criterion. That is, the optimal deep neural network DNNᵢ₋₁ and the optimal chip design Chipᵢ may be obtained in two consecutive executions (i.e., the (i−1)^{th} execution and i^{th} execution) of the optimization method. Thus, as a result of the present method, the chip design Chipᵢ and the deep neural network DNNᵢ₋₁ may be provided in order to perform the desired machine learning task. For example, one may assume that the optimization method converges after 10 executions i.e., the iterative process comprises 10 executions of the optimization method. This would result in the chip design Chip₁₀ that is the optimal chip to execute the deep neural network DNN₉ that is obtained from the 9^{th} execution of the optimization method (9^{th} execution of the second optimization step). Thus, the chip Chip₁₀ and the deep neural network DNN₉ may be provided in order to perform the desired machine learning task. The present subject matter may thus enable to co-explore the architecture search space and hardware components space for co-designing the deep neural network and corresponding chip design. The computer system may, for example, consume a dataset, a set of deep neural networks operations and a set of hardware components and may output an optimized chip design and a trained deep neural network without any human intervention.

In one example, the convergence criterion may require that a maximum number N of repetitions is reached. That is, the maximum number N of repetitions is for providing deep neural network DNNᵢ₋₁ and chip design Chipᵢ is the number i of executions minus one, i.e., N=i−1. Using a fixed number of repetitions may enable a controlled execution of the present method. For example, the maximum number of repetitions may be defined/predicted from a history of executions of the deep neural networks. Alternatively, the convergence criterion may require that the hardware performance metric HWPMᵢ has a predefined optimal value and/or the machine learning task performance metric MLPMᵢ₋₁ has a predefined optimal value. Controlling the convergence based on the optimal metric values may be advantageous as it may provide optimal chip designs and deep neural network architectures.

The convergence criterion is determined based on that both the provided chip design Chipᵢ and the deep neural network DNNᵢ₋₁ have the respective optimal values. Alternatively, the convergence criterion may require that one of provided chip design Chipᵢ and the deep neural network DNNᵢ₋₁ has an optimal value. This may save processing resources as the iterative process may quickly converge while still providing desired performances e.g., this may be useful for a user requiring a chip design with the best performances while the deep neural network can be used with non-optimal performances e.g., for testing purpose.

In one example, the initialization method and the iterative process may be repeated until the hardware performance metric has a predefined optimal value and/or the machine learning task performance metric has a predefined optimal value. In this case, the convergence criterion may require that a maximum number of repetitions is reached. In each repetition of the initialization method and the iterative process, the initialization method may result in a different pair of initial deep neural network and initial chip design. In each repetition of the initialization method and the iterative process, the same or different maximum number of repetitions may be required by the convergence criterion. This may result in multiple pairs of optimized chip designs and deep neural network architectures e.g., (Chipᵢ, DNNᵢ₋₁), (Chipⱼ, DNNⱼ₋₁) etc, where i and j are the maximum number of executions, where i=j or i≠j. These pairs may be compared against each other and the pair that provides the optimal value of the hardware performance metric and/or the optimal value of the machine learning task performance metric may be provided. This example may particularly be advantageous in case the convergence criterion of the optimization method is based on a maximum number of executions, that is the pairs such as (Chipᵢ, DNNᵢ₋₁) and (Chipⱼ, DNNⱼ₋₁) are obtained after a fixed number of executions.

In one example, the repetition of the initialization method and the iterative process is performed in parallel for the different initial deep neural networks and initial chip designs. This may speed up the execution of the present method.

In one example, the first optimization step is performed concurrently or in parallel with the second optimization step. This may further speed up the execution of the present method. This example may particularly be advantageous in case the second optimization step does not require an input from the first optimization step.

In one example, the method may automatically be executed upon receiving a request to perform the desired machine learning task or on a periodic basis e.g., every month. This may further speed up the execution of the present method by preventing any human intervention.

In one example, the first optimization step comprises repeatedly performing: step A1): modifying the current chip design by adding one or more components and/or removing one or more components and/or replacing one or more components and/or placing one or more components in a different place on the chip, and step B1): replacing the current chip design by the modified chip design if the hardware performance metric of the modified chip design is better than the hardware performance metric of the modified chip design. The modification is performed in step A1) such that the resulting chip design can execute the current deep neural network. The repetition of steps A1)-B1) may be performed until a first stopping criterion is fulfilled. Thus, the first optimization step may provide an iterative search for an optimal chip design.

The first stopping criterion requires a maximum number of repetitions of steps A1)-B1) is reached or that an optimal value of the hardware performance metric is obtained.

In one example, the second optimization step comprises repeatedly performing: step A2): selecting a deep neural network from the architecture search space such that the selected deep neural network and the current deep neural network have a maximum dissimilarity level, and step B2): replacing the current deep neural network by the selected deep neural network if the machine learning task performance metric of the selected deep neural network is better than the machine learning task performance metric of the current deep neural network. The repetition of steps A2)-B2) may be performed until a second stopping criterion is fulfilled. Thus, the second optimization step may provide an iterative search for an optimal deep neural network. Using the dissimilarity criterion may enable a quick convergence of the iterative process. The dissimilarity criterion may require that the selected deep neural network architecture to be highly dissimilar to the current deep neural network architecture.

The second stopping criterion may require a maximum number of repetitions of steps A2)-B2) is reached or that an optimal value of the machine learning task performance metric is obtained.

In one example, the second optimization step may comprise computing the dissimilarity level between the two compared networks. The dissimilarity level may, for example, be a difference in number of hardware components (e.g., analogue tiles) required by the two networks, and/or a difference in hardware mappings or deployments of the two networks. In another example, the dissimilarity level may be obtained by comparing embeddings that represent the two compared networks. For that, a graph neural network (GNN) may, for example, be used to encode the two compared networks in two embeddings respectively. Theses embeddings may be compared in order to determine the dissimilarity level. In another example, the dissimilarity level may be the difference between hyperparameters' values of the two networks.

In one example, the second optimizer may optimize the current deep neural network DNNᵢ using both the machine learning task performance metric MLPMᵢ and the hardware performance metric. For that, the first optimizer may have to provide or send to the second optimizer said hardware performance metric as evaluated by the first optimizer. The present subject matter may provide alternative advantageous examples for this provision of the hardware performance metric.

In one example, the second optimization step comprises optimizing the current deep neural network DNNᵢ to improve the machine learning task performance metric MLPMᵢ while satisfying the hardware performance metric of the chip design that is obtained after every n^{th} execution, where n is an integer within a predefined set of numbers. For example, the first optimizer provides the hardware performance metric HWPMᵢ for a specific set of values of n e.g., if the set of values is {3, 7, 23}, the first optimizer may provide to the second optimizer the hardware performance metrics HWPM₃, HWPM₇ and HWPM₂₃ that have been computed in the third, 7^{th} and 23^{rd} execution of the optimization method respectively. The optimization of the deep neural network based on both the machine learning task performance metric and the provided hardware performance metric may be performed as follows. For example, the second optimizer may use a multi-objective optimization algorithm that considers both the provided hardware performance metric and the machine learning task performance metric. Following the above example, the second optimizer may use during the 4^{th} or 5^{th} or 6^{th} execution of the optimization method the respective machine learning task performance metric MLPM₄, MLPM₅ or MLPM₆ and the lastly provided hardware performance metric HWPM₃ for the multi-objective optimization. During the multi-objective optimization, the second optimizer may, for example, deploy the DNN in the lastly optimized chip design, run a few inferences and extract the HWPM.

In one example, during the i^{th} execution of the optimization method, the first optimizer provides to the second optimizer the hardware performance metric HWPMᵢ in case the hardware performance metric HWPMᵢ of the current execution differs by a minimum value from the hardware performance metric HWPMᵢ₋₁ of the previous execution. In this case, the second optimizer may optimize the current deep neural network DNNᵢ using both the machine learning task performance metric MLPMᵢ and the provided hardware performance metric HWPMᵢ₋₁. The second optimizer may optimize the current deep neural network DNNᵢ to improve the machine learning task performance metric MLPMᵢ while satisfying the lastly provided hardware performance metric e.g., the lastly provided metric may be HWPMᵢ₋₁ if HWPMᵢ does not differ from HWPMᵢ₋₁ by the minimum value.

The first optimization step performs chip placement optimization. The chip placement may, for example, use a reinforcement learning agent where the actions comprise one or more of the following: switching the place of two components, modifying one component and adding or removing a component. The second optimization step may advantageously be performed by using a reinforcement learning approach, Bayesian optimization or an evolutionary algorithm in order to select a deep neural network.

In one example, the architecture search space comprises one or more types of deep neural networks, wherein a type of the deep neural network comprises: a transformer or a convolutional neural network or a recurrent neural network. This enables embodiments of the present invention to execute a vast variety of machine learning tasks.

In one example, the desired machine learning task may be a classification task, or a regression task or an anomaly detection task or any task that can be learned by the deep neural network.

The present subject matter provides a system and method to automatically design heterogenous chips by optimally assembling the placement of the low level components to minimize the communication and computation latency and energy consumption for deep learning applications. This methodology is implemented to realize one or more of the following advantages. The system can effectively and automatically generate the optimal component placement that will result in computations efficiencies of neural networks, e.g., low latency and energy consumption, for a particular task. Because the system may explore several deep neural networks simultaneously, the final chip design may be optimal for the type of networks that have been included in the search space. The system can automatically identify the optimal neural network associated with the chip design for a particular task. The system can be used to enhance and validate current chip designs by analysing the data generated by chip design exploration. The method may involve hardware and software co exploration for both neural architectures and chip design to find the best neural architecture and the best chip design for optimal performance for various deep learning tasks.

In one example, a deep neural network may involve an input layer, two fully connected hidden layers and an output layer. Each fully connected layer is followed by an activation function. The two activation functions may be different e.g., the two activation functions may be ReLu and softmax. The deep neural network may, for example, be represented as follows: Input->fully connected layer->ReLu->fully connected layer->softmax->output. The chip design may, for example, be built for this deep neural network (DNN) as follows. The hardware component space may provide component C1 that executes Matrix-Vector Multiplication (MVM) and C2 that can apply both activation functions, ReLu and softmax. An initial chip design may be initialized with one component (e.g., C1). In step S1), the DNN may be deployed in the current chip design. It may be checked in step S2) whether the deployment is successful. If the DNN fails to be deployed, the HWPM of the current chip design may be set in step S3) to infinity. If the DNN is successfully deployed, the HWPM may be evaluated in step S4) by running the deployed DNN in the current chip design. Based on the current HWPM, the chip design may be optimized in step S5), and the optimised chip design may be used as a current chip design for the next iteration. Steps S1) to S5) may be repeated for a number of iterations e.g., until an optimal value of the HWPM is obtained. This may, for example, result in the following chip design: [C1][C2][C1][C2] for executing the DNN.

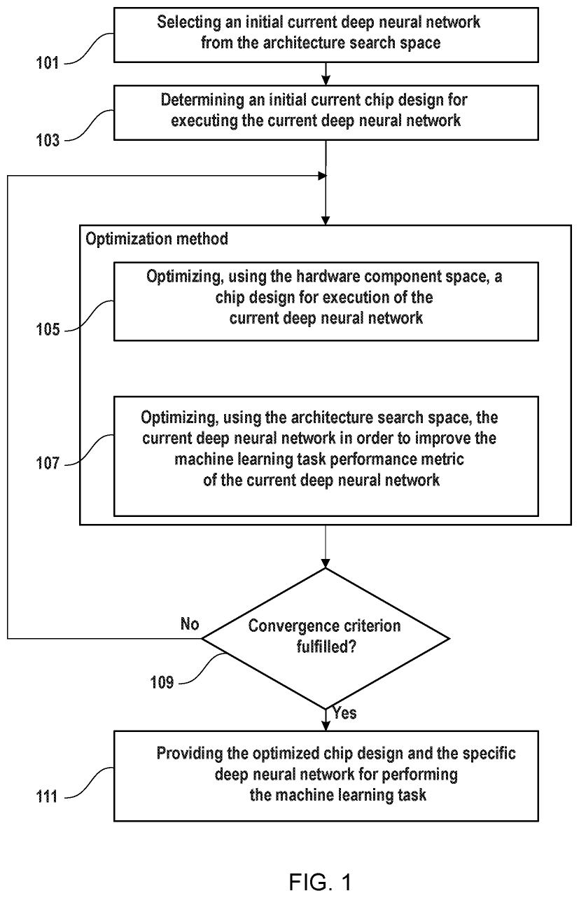

FIG. 1 is a flowchart of a method for performing a machine learning task in accordance with an example of the present subject matter. An initial deep neural network DNN₁ is selected in step 101 from the architecture search space. The initial deep neural network DNN₁ has a machine learning task performance metric MLPM₁ when performing the machine learning task. An initial chip design Chip₁ for executing the deep neural network DNN₁ is determined in step 103 using the hardware components space. The initial chip design Chip₁ has a hardware performance metric HWPM₁ for implementing the initial deep neural network DNN₁.

Steps 101 and 103 form steps of the initialization method. The four elements: Chip₁, DNN₁, MLPM₁ and HWPM₁ are provided as input to the optimization method. The optimization method comprises steps 105 and 107. In some embodiments, Step 105 is referred to as the first optimization step and step 107 is referred to as the second optimization step, where the first optimization step 105 is performed by a first optimizer and the second optimization step 107 is performed by a second optimizer.

In various embodiments, the optimization method is executed one or more times until the convergence criterion is fulfilled. For a current i^{th} execution of the optimization method, steps 105 and 107 may be described as follows, where i varies between 1 and the number of executions of the optimization method required to fulfill the convergence criterion.

The current chip design Chipᵢ is optimized in step 105 by, for example, modifying the chip design Chipᵢ one or more times using components from the hardware components space. The optimization is performed to improve the hardware performance metric HWPMᵢ of the current chip design Chipᵢ for execution of the current deep neural network DNNᵢ. The optimization in step 105 results in a chip design Chipᵢ₊₁ optimized for execution of the current deep neural network DNNᵢ and which is the current chip design for a next execution of the optimization method.

The current deep neural network DNNᵢ is optimized in step 107 using the architecture search space. The optimization is performed by selecting deep neural networks from the architecture search space. The optimizing is performed in order to improve the machine learning task performance metric MLPMᵢ of the current deep neural network DNNᵢ. The optimization in step 107 may result in a deep neural network DNNᵢ₊₁ which is the current deep neural network for a next execution of the optimization method. The deep neural network DNNᵢ₊₁ may have been selected from the architecture search space. In one example implementation of step 107, the optimization of the deep neural network in step 107 may, for example, be performed using the chip design Chipᵢ₊₁ obtained in step 105 e.g., by executing the deep neural network on the chip design Chipᵢ₊₁ obtained in step 105 in order to evaluate the machine learning task performance metric. Alternatively, the optimization of the deep neural network in step 107 may, for example, be performed without using the chip design Chipᵢ₊₁ obtained in step 105 by, for example, a software-based evaluation using CPUs.

For example, for the first execution (i.e., i=1) of the optimization method, the four elements Chip₁, DNN₁, MLPM₁ and HWPM₁ of the input provided by the initialization method may be used in steps 105 and 107 in order to determine four elements Chip₂, DNN₂, MLPM₂ and HWPM₂ which may be used as input for the second execution of the optimization method. In step 109, the optimization method (e.g., steps 105 and 107) is repeated until convergence criterion is fulfilled. In solutions where the convergence criterion is not fulfilled, the optimization method may be repeated. In case the convergence criterion is fulfilled, the optimized chip design Chipᵢ and the specific deep neural network DNNᵢ₋₁ may be provided in step 111 for performing the machine learning task.

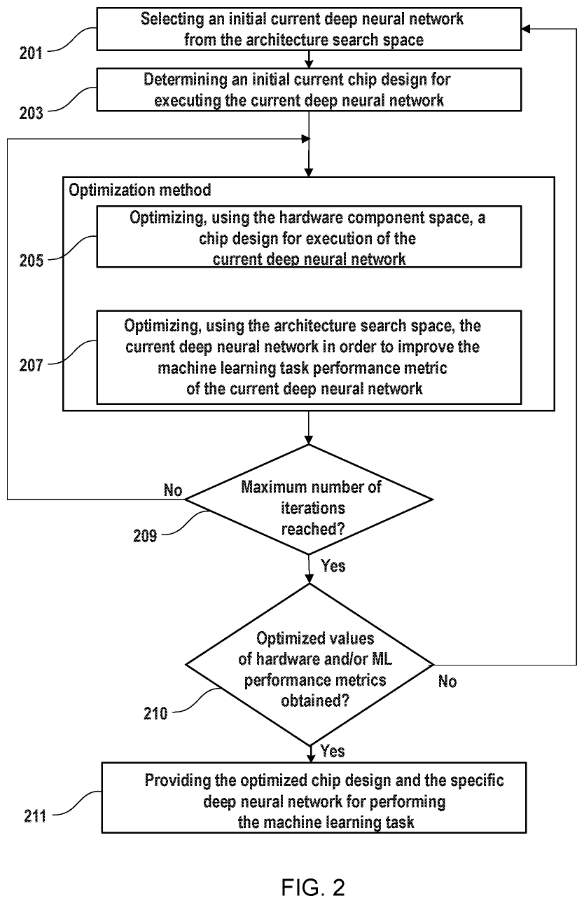

FIG. 2 is a flowchart of a method for performing a machine learning task in accordance with an example of the present subject matter.

The method of FIG. 2 comprises steps 201 to 207 which are steps 101 to 107 respectively as described with reference to FIG. 1. An initial deep neural network DNN₁ is selected in step 201 from the architecture search space. The initial deep neural network DNN₁ has a machine learning task performance metric MLPM₁ when performing the machine learning task. An initial chip design Chip₁ for executing the deep neural network DNN₁ is determined in step 203 using the hardware components space. The initial chip design Chip₁ has a hardware performance metric HWPM₁ for implementing the initial deep neural network DNN₁. Step 205 is referred to as the first optimization step and step 207 is referred to as the second optimization step, where the first optimization step 205 is performed by a first optimizer and the second optimization step 207 is performed by a second optimizer.

In step 209, the optimization method is repeated until a maximum number of repetitions is reached. In case the maximum number is not reached, the optimization method is repeated. In case the maximum number is reached, the result in a chip design Chipᵢ and associated deep neural network DNNᵢ₋₁ is provided (step 211). In step 210, the hardware performance metric of the chip design Chipᵢ is checked to ensure the optimal value and/or the machine learning task performance metric of the specific deep neural network DNNᵢ₋₁ is the optimal value. In case none of the hardware performance metric of the chip design Chipᵢ and the machine learning task performance metric of the specific deep neural network DNNᵢ₋₁ have the optimal values, the method may be repeated by selecting initial chip design and initial deep neural network. In case the hardware performance metric HWPMᵢ of the chip design Chipᵢ is the optimal value and/or the machine learning task performance metric MLPMᵢ₋₁ of the specific deep neural network DNNᵢ₋₁ is the optimal value, the optimized chip design Chipᵢ and the specific deep neural network DNNᵢ₋₁ may be provided in step 211 for performing the machine learning task.

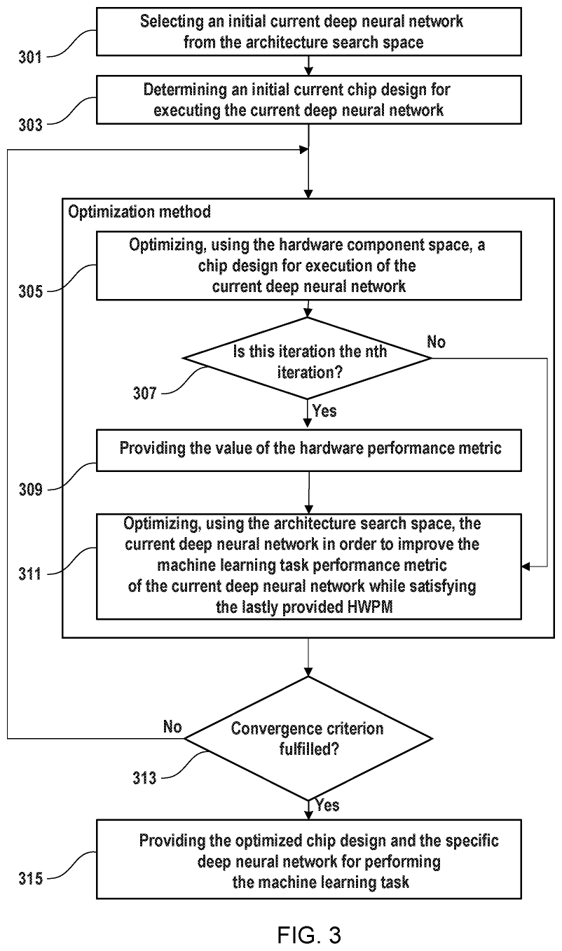

FIG. 3 is a flowchart of a method for performing a machine learning task in accordance with an example of the present subject matter. An initial deep neural network DNN₁ may be selected in step 301 from the architecture search space. The initial deep neural network DNN₁ has a machine learning task performance metric MLPM₁ when performing the machine learning task. An initial chip design Chip₁ for executing the deep neural network DNN₁ may be determined in step 303 using the hardware components space. The initial chip design Chip₁ has a hardware performance metric HWPM₁ for implementing the initial deep neural network DNN₁.

Steps 301 and 303 may form steps of the initialization method. The four elements: Chip₁, DNN₁, MLPM₁ and HWPM₁ may be provided as input to the optimization method. The optimization method comprises steps 305 to 311. Step 305 may be referred to as the first optimization step and step 311 may be referred to as the second optimization step. The optimization method may be executed one or more times until the convergence criterion is fulfilled. The convergence criterion may, for example, require that a maximum number of repetitions of the optimization method is reached or that the hardware performance metric has a predefined optimal value and/or the machine learning task performance metric has a predefined optimal value.

For a current i^{th} execution of the optimization method, steps 305 to 311 may be described as follows, where i varies between 1 and the number of executions of the optimization method that fulfills the convergence criterion. The current chip design Chipᵢ may be optimized in step 305 by, for example, modifying the chip design Chipᵢ one or more times using components from the hardware components space. The optimizing is performed in order to improve the hardware performance metric HWPMᵢ of the current chip design Chipᵢ for execution of the current deep neural network DNNᵢ. The optimization in step 305 may result in a chip design Chipᵢ₊₁ optimized for execution of the current deep neural network DNNᵢ and which is the current chip design for a next execution of the optimization method.

It may be determined in step 307 whether the current execution number i is one of a selected set of numbers. If the current execution number i is not one of the selectet set of numbers step 311 may be performed; otherwise, the value of the hardware performance metric HWPMᵢ may be provided in step 309 so that it can be used by the second optimization step.

The current deep neural network DNNᵢ may be optimized in step 311 using the architecture search space. The optimization may be performed by selecting deep neural networks from the architecture search space. The optimizing is performed in order to improve the machine learning task performance metric MLPMᵢ of the current deep neural network DNNᵢ while satisfying the lastly provided hardware performance metric in step 309. The optimization of the deep neural network in step 311 may, for example, be performed using the optimized chip design Chipᵢ₊₁ obtained in step 305 e.g., by executing the deep neural network on the chip design Chipᵢ₊₁ obtained in step 305 in order to evaluate the machine learning task performance metric and to check the satisfaction of the lastly provided hardware performance metric. The optimization in step 311 may result in a deep neural network DNNᵢ₊₁ which is the current deep neural network for a next execution of the optimization method. The deep neural network DNNᵢ₊₁ may have been selected from the architecture search space.

It may be determined in step 313 whether the convergence criterion is fulfilled. In case the convergence criterion is not fulfilled the optimization method may be repeated. In case the convergence criterion is fulfilled, the optimized chip design Chipᵢ and the specific deep neural network DNNᵢ₋₁ may be provided in step 315 for performing the machine learning task.

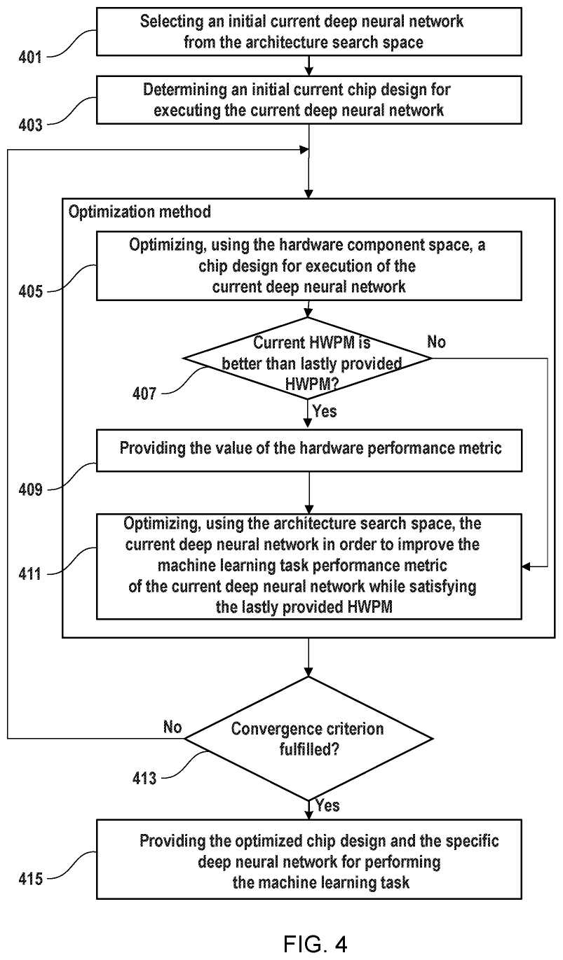

FIG. 4 is a flowchart of a method for performing a machine learning task in accordance with an example of the present subject matter. An initial deep neural network DNN₁ may be selected in step 401 from the architecture search space. The initial deep neural network DNN₁ has a machine learning task performance metric MLPM₁ when performing the machine learning task. An initial chip design Chip₁ for executing the deep neural network DNN₁ may be determined in step 403 using the hardware components space. The initial chip design Chip₁ has a hardware performance metric HWPM₁ for implementing the initial deep neural network DNN₁.

Steps 401 and 403 may form steps of the initialization method. The four elements: Chip₁, DNN₁, MLPM₁ and HWPM₁ may be provided as input to the optimization method. The optimization method comprises steps 405 to 411. Step 405 may be referred to as the first optimization step and step 411 may be referred to as the second optimization step. The optimization method may be executed one or more times until the convergence criterion is fulfilled. The convergence criterion may, for example, require that a maximum number of repetitions of the optimization method is reached or that the hardware performance metric has a predefined optimal value and/or the machine learning task performance metric has a predefined optimal value.

For a current i^{th} execution of the optimization method, steps 405 to 411 may be described as follows, where i varies between 1 and the number of executions of the optimization method that fulfills the convergence criterion. The current chip design Chipᵢ may be optimized in step 405 by, for example, modifying the chip design Chipᵢ one or more times using components from the hardware components space. The optimizing is performed in order to improve the hardware performance metric HWPMᵢ of the current chip design Chipᵢ. The optimization in step 405 may result in a chip design Chipᵢ₊₁ which is the current chip design for a next execution of the optimization method.

It may be determined in step 407 whether the hardware performance metric HWPMᵢ is better than the lastly provided hardware performance metric e.g., hardware performance metric HWPMᵢ₋₁. If the hardware performance metric HWPMᵢ is not better than the lastly provided hardware performance metric, step 411 may be performed; otherwise, the value of the hardware performance metric HWPMᵢ may be provided in step 409 so that it can be used by the second optimization step.

The current deep neural network DNNᵢ may be optimized in step 411 using the architecture search space. The optimization may be performed by selecting deep neural networks from the architecture search space. The optimizing is performed in order to improve the machine learning task performance metric MLPMᵢ of the current deep neural network DNNᵢ while satisfying the lastly provided hardware performance metric in step 409. The optimization of the deep neural network in step 411 may, for example, be performed using the optimized chip design Chipᵢ₊₁ obtained in step 405 e.g., by executing the deep neural network on the chip design Chipᵢ₊₁ obtained in step 405 in order to evaluate the machine learning task performance metric and to check the satisfaction of the lastly provided hardware performance metric. The optimization in step 411 may result in a deep neural network DNNᵢ₊₁ which is the current deep neural network for a next execution of the optimization method. The deep neural network DNNᵢ₊₁ may have been selected from the architecture search space.

It may be determined in step 413 whether the convergence criterion is fulfilled. In case the convergence criterion is not fulfilled the optimization method may be repeated. In case the convergence criterion is fulfilled, the optimized chip design Chipᵢ and the specific deep neural network DNNᵢ₋₁ may be provided in step 415 for performing the machine learning task.

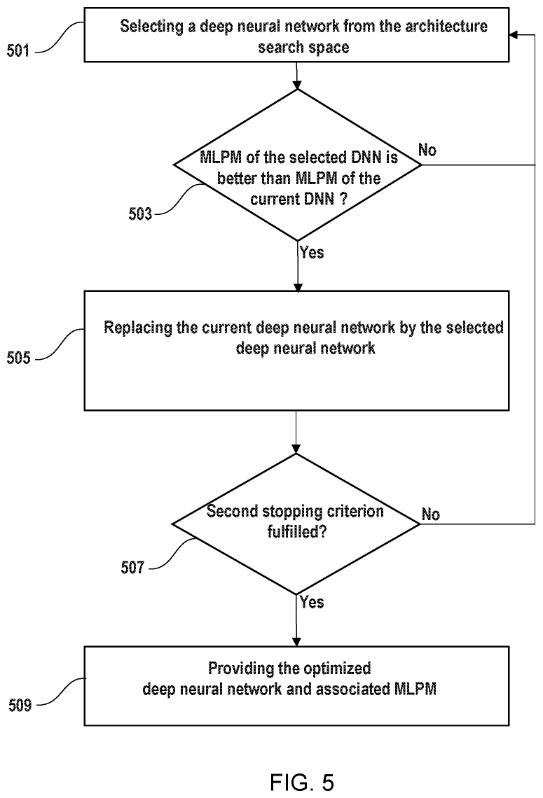

FIG. 5 is a flowchart of a method for performing the second optimization step in accordance with an example of the present subject matter. The method of FIG. 5 may for example provide an implementation detail of step 107 of FIG. 1.

A deep neural network may be selected from the architecture search space in step 501. It may be determined in step 503 whether the machine learning task performance metric of the selected deep neural network is better than the machine learning task performance metric MLPMᵢ of the current deep neural network DNNᵢ. In case the machine learning task performance metric of the selected deep neural network is not better than the machine learning task performance metric MLPMᵢ of the current deep neural network DNNᵢ, another deep neural network may be selected in step 501 followed by step 503 again. In case the machine learning task performance metric of the selected deep neural network is better than the machine learning task performance metric MLPMᵢ of the current deep neural network DNNᵢ, the current deep neural network DNNᵢ may be replaced by the selected deep neural network in step 505.

It may be determined in step 507 whether the second stopping criterion is fulfilled. In one example, the second stopping criterion may require a maximum number of repetitions of steps 501 to 505 is reached or that an optimal value of the machine learning task performance metric is obtained. In case the second stopping criterion is not fulfilled, the method may be repeated, going back to step 501. In case the second stopping criterion is fulfilled, the selected deep neural network that replaced the current deep neural network may be provided in step 509 in association with its machine learning task performance metric. Following the notation of FIG. 1, the selected deep neural network noted as DNNᵢ₊₁ may be provided in step 509 in association with the machine learning task performance metric MLPMᵢ₊₁.

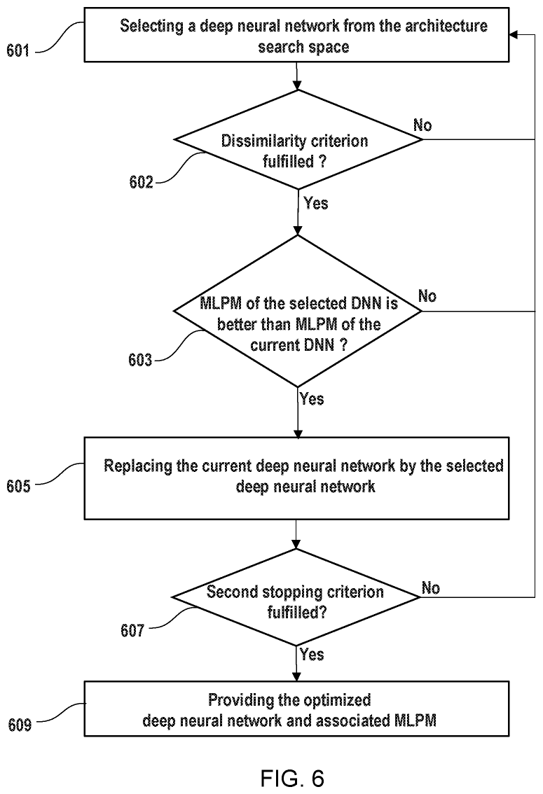

FIG. 6 is a flowchart of a method for performing the second optimization step in accordance with an example of the present subject matter. The method of FIG. 6 may for example provide an implementation detail of step 107 of FIG. 1. A deep neural network may be selected from the architecture search space in step 601. It may be determined in step 602 whether a dissimilarity criterion is fulfilled. The dissimilarity criterion may require that a dissimilarity value between compared deep neural networks is higher than a minimum difference. The dissimilarity value may for example, be obtained by encoding the two deep neural networks by a graph convolutional neural network (GNN) e.g., in order to obtain two embeddings of the two deep neural networks. These embeddings may be compared to obtain the dissimilarity level.

In case the dissimilarity criterion is not fulfilled, another deep neural network may be selected in step 601 followed by step 602 again. In case the dissimilarity criterion is fulfilled, it may be determined in step 603 whether the machine learning task performance metric of the selected deep neural network is better than the machine learning task performance metric MLPMᵢ of the current deep neural network DNNᵢ. In case the machine learning task performance metric of the selected deep neural network is not better than the machine learning task performance metric MLPMᵢ of the current deep neural network DNNᵢ, another deep neural network may be selected in step 601 followed by steps, 602 and 603 again.

In case the machine learning task performance metric of the selected deep neural network is better than the machine learning task performance metric MLPMᵢ of the current deep neural network DNNᵢ, the current deep neural network DNNᵢ may be replaced by the selected deep neural network in step 605. It may be determined in step 607 whether the second stopping criterion is fulfilled. In one example, the second stopping criterion may require a maximum number of repetitions of steps 601 to 605 is reached or that an optimal value of the machine learning task performance metric is obtained. In case the second stopping criterion is not fulfilled, the method may be repeated, going back to step 601.

In case the second stopping criterion is fulfilled, the selected deep neural network that replaced the current deep neural network and associated machine learning task performance metric may be provided in step 609. Following the notation of FIG. 1, the selected deep neural network noted as DNNᵢ₊₁ may be provided in step 609 in association with the machine learning task performance metric MLPMᵢ₊₁.

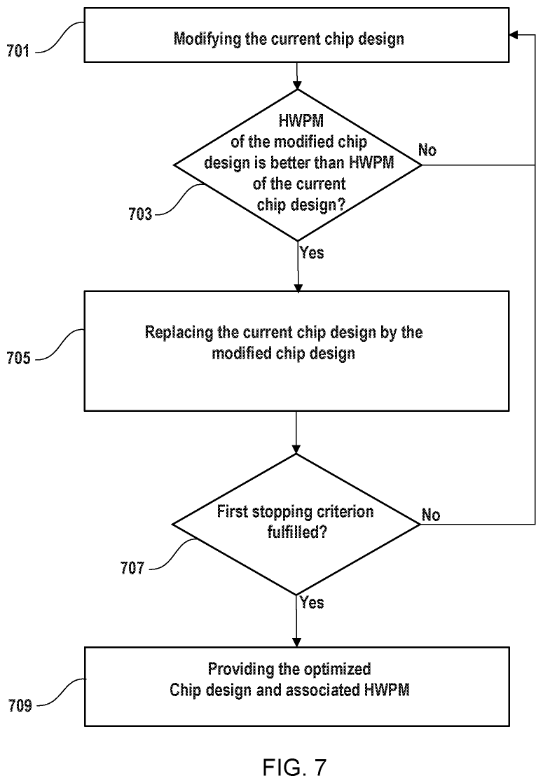

FIG. 7 is a flowchart of a method for performing the first optimization step in accordance with an example of the present subject matter. The method of FIG. 7 may for example provide an implementation detail of step 105 of FIG. 1.

The current chip design Chipᵢ may be modified in step 701 using the hardware components space, resulting in a modified chip design having a hardware performance metric. The modification may, for example, be performed by adding one or more components and/or removing one or more components and/or replacing one or more components and/or placing one or more components in a different place on the chip. It may be determined in step 703 whether the hardware performance metric of the modified chip design is better than the hardware performance metric HWPMᵢ of the current chip design Chipᵢ.

In case the hardware performance metric of the modified chip design is better than the hardware performance metric HWPMᵢ of the current chip design Chipᵢ, the current chip design Chipᵢ may be replaced by the modified chip design in step 705. It may be determined in step 707 whether the first stopping criterion is fulfilled. In case the first stopping criterion is not fulfilled, the method may be repeated, going back to step 701. In one example, the first stopping criterion may require a maximum number of repetitions of steps 701 to 705 is reached or that an optimal value of the hardware performance metric is obtained.

In case the first stopping criterion is fulfilled, the modified chip design that replaced the current chip design Chipᵢ and associated hardware performance metric may be provided in step 709. Following the notation of FIG. 1, the modified chip design network noted as Chipᵢ₊₁ may be provided in step 709 in association with the machine learning task performance metric HWPMᵢ₊₁.

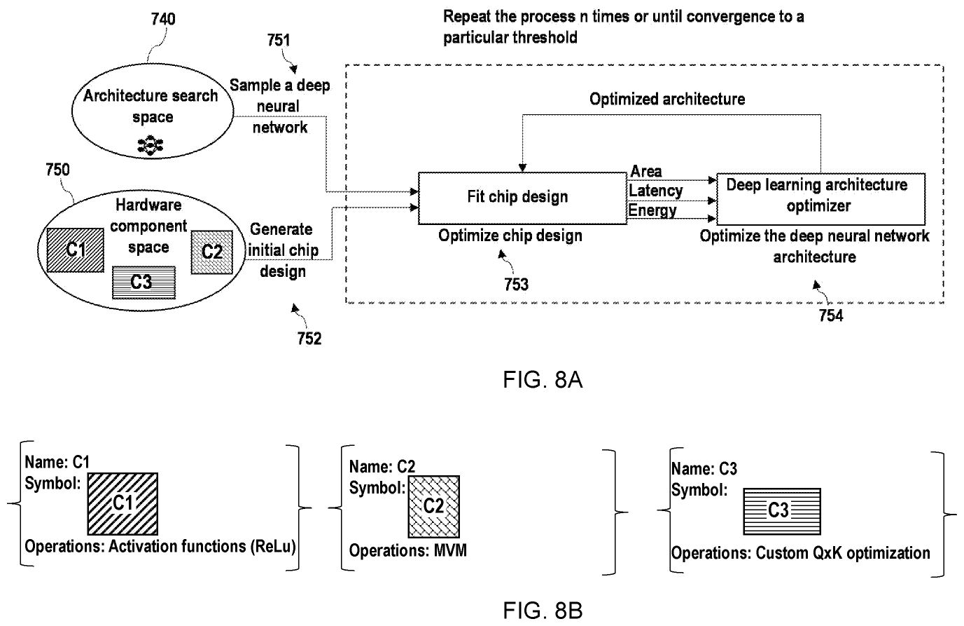

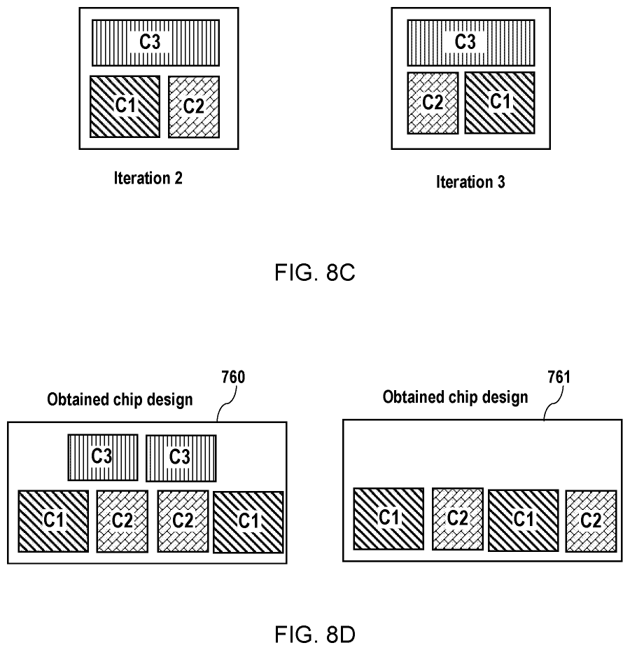

FIG. 8A is a diagram illustrating a method for performing an optimization in accordance with an example of the present subject matter.

An architecture search space 740 and a hardware components space 750 may be provided. The architecture search space 740 contains the deep neural networks applied to the targeted task. These neural networks can be configured to receive any kind of input and to generate any kind of classification or regression output. The architecture search space 740 may, for example, be a transformer-like architecture search space or ConvNet-like architecture search space. The hardware components space 750 may contain all possible hardware components. Each component can execute any type and number of operations. Each component includes its area, and the latency and energy consumption required by each operation. This space 750 can be described as a knowledge graph to account for the dependencies between the components. FIG. 8B depicts an example set of components of the hardware components space 750. The component named C1 may for example perform activation functions such as ReLu activations. The component named C2 may for example perform MVM operations and the component named C3 may for example perform a custom QxK optimization.

The architecture search space 740 and hardware components space 750 may enable to perform a design methodology of four stages 751, 752, 753 and 754.

A deep neural network architecture may be sampled in stage 751. Initially, a deep neural network is randomly sampled from the architecture search space. During the search methodology, however, the architecture may be selected based on two criteria: the exploration criteria (optimizing the performance such as accuracy) and the dissimilarity criteria. The dissimilarity criteria may help the sampled architectures be different enough to allow the chip design to generalize to various deep learning architectures.

An initial chip design may be generated in stage 752. The initial chip design can vary depending on the application. For example, one can start from scratch and initially define the chip with a single component. The single component may execute all the operations applied by the sampled deep learning architecture. A user defined starting point can also be defined. In this case, the designer may provide an initial assembling of the components, the methodology may then automatically adapt this design to the architecture search space and thus the task.

The chip design may be optimized in stage 753. For a few iterations, a controller may modify the chip design by adding or removing components, replacing a component, and placing a component in a different place on the chip. In each iteration, the controller may use the latency, energy and area as a penalty to optimize the chip design. FIG. 8C depicts an example optimization of the chip design that is performed in the second iteration in order to obtain the chip design of the third iteration. The chip design has three components C1, C2 and C3 that enables the execution of the deep neural network architecture. The optimization consisted in exchanging the placement of the components C2 and C1 in the chip design.

The deep neural network architecture may be optimized in stage 754. The sampled architecture is then evaluated on the target task and the performance along with the hardware constraints, e.g., area, latency, and energy consumption. These evaluations may be used by the deep learning architecture optimizer to efficiently explore the architecture search space. The optimizer can be any optimization algorithm. For example, a reinforcement learning controller can be used to generate a sequence of possible properties that defines the next deep neural network in a small architecture search space. In a huge architecture search space, an evolutionary algorithm may be used to achieve an optimal trade-off between exploration and exploitation of the search space.

The process (including stages 753 and 754) may be repeated several times to achieve convergence of both hardware chip design and deep neural network search. FIG. 8D depicts an example obtained chip design 760 in case the architecture search space 740 is a transformer-like architecture search space. FIG. 8D further depicts an example obtained chip design 761 in case the architecture search space 740 is a ConvNet-like architecture search space. The obtained chip design 760 and 761 may be the smallest chip that can execute all architectures in the search space 740 in an optimized manner. Component C3 is not part of chip design 761 as ConvNets do not execute the QxK operation optimized by component C3. However, transformers include these operations. ConvNets include skip connection where the output of the activation in component C1 is sent to the next MVM in component C2.

Computing environment 800 contains an example of an environment for the execution of at least some of the computer code involved in performing the inventive methods, such as a code 900 for co-designing a deep neural network and a chip for performing a machine learning task, as discussed herein. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

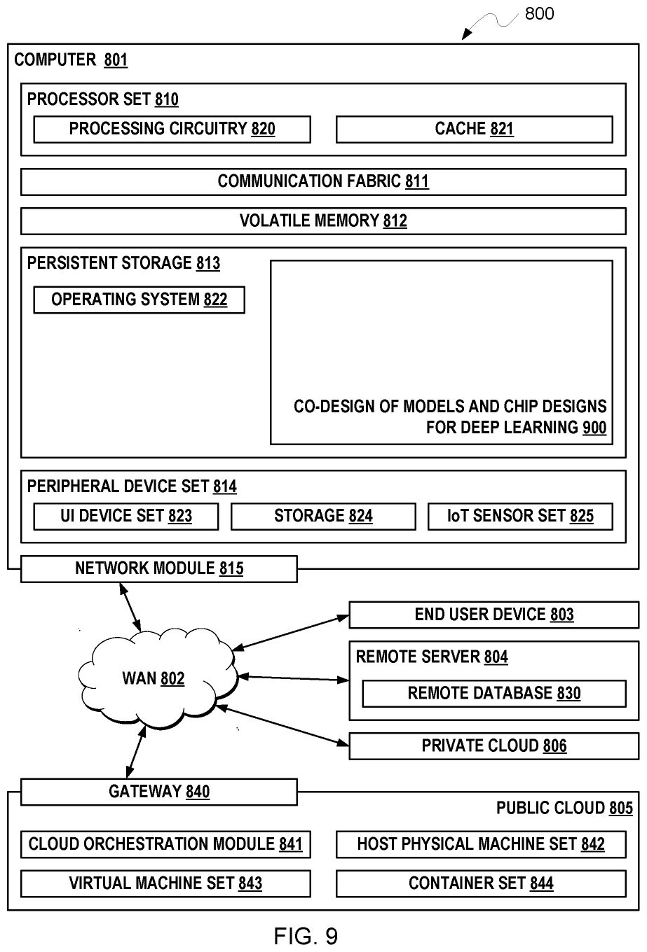

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 9. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
selecting an architecture search space and a hardware components space, wherein the architecture search space comprises architectures and the hardware components space comprising components for executing a deep neural network;
selecting an initial deep neural network from the architecture search space, the initial deep neural network having a machine learning task performance metric for an evaluation of the initial deep neural network;
determining an initial chip design for executing the initial deep neural network, wherein the initial chip design has a hardware performance metric for implementing the initial deep neural network;
executing an optimization method, the optimization method comprising:
improving, by a first optimizer, the hardware performance metric of the initial chip design by modifying the initial chip design one or more times using the components from the hardware components space, the improving the hardware performance metric resulting in a revised chip design for a next phase of chip design improvement; and
improving, by a second optimizer, the machine learning task performance metric of the initial deep neural network by selecting a second deep neural network from the architecture search space, the improving the machine learning task performance metric resulting in a revised deep neural network for a next phase of deep neural network improvement;
repeating execution of the optimization method by entering the next phase of chip design improvement using the revised chip design as the initial chip design and by entering the next phase of deep neural network improvement using the revised deep neural network as the initial deep neural network; and
responsive to a combination of the hardware performance metric for a specific chip design and the machine learning task performance metric for a specific deep neural network meeting a convergence criterion, providing the specific chip design and the specific deep neural network for performing the machine learning task.

2. The method of claim 1, wherein improving the machine learning task performance metric of the initial deep neural network includes:
satisfying the hardware performance metric for the revised chip design obtained after every n^{th} repetition of the optimization method, where n is an integer within a predefined set of numbers.

3. The method of claim 1, wherein:
the first optimizer provides to the second optimizer a revised hardware performance metric when a hardware performance metric value differs by a minimum value from a immediately previous hardware performance metric value; and
improving, by a second optimizer, the machine learning task performance metric of the initial deep neural network is performed while satisfying the revised hardware performance metric.

4. The method of claim 1, wherein the convergence criterion requires the hardware performance metric to have a predefined optimal value and/or the machine learning task performance metric to have a predefined optimal value.

5. The method of claim 1, wherein:
the convergence criterion requires, before providing the specific chip design:
a specified number of repeated executions of the optimization method; and
either
(a) the hardware performance metric value meets a predefined target value; or
(b) the machine learning task performance metric value meets a predefined target value.

6. The method of claim 1, wherein the repeating execution of the optimization method is performed in parallel for multiple initial deep neural networks and corresponding initial chip designs.

7. The method of claim 1, wherein:
selecting the second deep neural network from the architecture search space is performed such that the second deep neural network and the initial deep neural network have a maximum dissimilarity level;
replacing the initial deep neural network by the second deep neural network if the machine learning task performance metric value obtained with the second deep neural network is closer to a target value than the machine learning task performance metric value obtained with the initial deep neural network; and
improving the machine learning task performance metric is performed repeatedly by the second optimizer until a stopping criterion is reached.

8. A computer program product comprising:
one or more computer-readable storage media and program instructions stored on the one or more computer-readable storage media, the program instructions comprising:
program instructions to select an architecture search space and a hardware components space, wherein the architecture search space comprises architectures and the hardware components space comprising components for executing a deep neural network;
program instructions to select an initial deep neural network from the architecture search space, the initial deep neural network having a machine learning task performance metric for an evaluation of the initial deep neural network;
program instructions to an initial chip design for executing the initial deep neural network, wherein the initial chip design has a hardware performance metric for implementing the initial deep neural network;
program instructions to execute an optimization method, the optimization method comprising:
improving, by a first optimizer, the hardware performance metric of the initial chip design by modifying the initial chip design one or more times using the components from the hardware components space, the improving the hardware performance metric resulting in a revised chip design for a next phase of chip design improvement; and
improving, by a second optimizer, the machine learning task performance metric of the initial deep neural network by selecting a second deep neural network from the architecture search space, the improving the machine learning task performance metric resulting in a revised deep neural network for a next phase of deep neural network improvement;
program instructions to repeat execution of the optimization method by entering the next phase of chip design improvement using the revised chip design as the initial chip design and by entering the next phase of deep neural network improvement using the revised deep neural network as the initial deep neural network; and
program instructions to, responsive to a combination of the hardware performance metric for a specific chip design and the machine learning task performance metric for a specific deep neural network meeting a convergence criterion, provide the specific chip design and the specific deep neural network for performing the machine learning task.

9. The computer program product of claim 8, wherein improving the machine learning task performance metric of the initial deep neural network includes:
satisfying the hardware performance metric for the revised chip design obtained after every n^{th} repetition of the optimization method, where n is an integer within a predefined set of numbers.

10. The computer program product of claim 8, wherein:
the first optimizer provides to the second optimizer a revised hardware performance metric when a hardware performance metric value differs by a minimum value from a immediately previous hardware performance metric value; and
improving, by a second optimizer, the machine learning task performance metric of the initial deep neural network is performed while satisfying the revised hardware performance metric.

11. The computer program product of claim 8, wherein the convergence criterion requires the hardware performance metric to have a predefined optimal value and/or the machine learning task performance metric to have a predefined optimal value.

12. The computer program product of claim 8, wherein:
the convergence criterion requires, before providing the specific chip design:
a specified number of repeated executions of the optimization method; and
either
(a) the hardware performance metric value meets a predefined target value; or
(b) the machine learning task performance metric value meets a predefined target value.

13. The computer program product of claim 8, wherein the repeating execution of the optimization method is performed in parallel for multiple initial deep neural networks and corresponding initial chip designs.

14. The computer program product of claim 8, wherein:
selecting the second deep neural network from the architecture search space is performed such that the second deep neural network and the initial deep neural network have a maximum dissimilarity level;
replacing the initial deep neural network by the second deep neural network if the machine learning task performance metric value obtained with the second deep neural network is closer to a target value than the machine learning task performance metric value obtained with the initial deep neural network; and
improving the machine learning task performance metric is performed repeatedly by the second optimizer until a stopping criterion is reached.

15. A computer system comprising:
one or more computer processors;
one or more computer readable storage media; and
program instructions stored on the computer readable storage media for execution by at least one of the one or more processors, the program instructions comprising:
program instructions to select an architecture search space and a hardware components space, wherein the architecture search space comprises architectures and the hardware components space comprising components for executing a deep neural network;
program instructions to select an initial deep neural network from the architecture search space, the initial deep neural network having a machine learning task performance metric for an evaluation of the initial deep neural network;
program instructions to an initial chip design for executing the initial deep neural network, wherein the initial chip design has a hardware performance metric for implementing the initial deep neural network;
program instructions to execute an optimization method, the optimization method comprising:
improving, by a first optimizer, the hardware performance metric of the initial chip design by modifying the initial chip design one or more times using the components from the hardware components space, the improving the hardware performance metric resulting in a revised chip design for a next phase of chip design improvement; and
improving, by a second optimizer, the machine learning task performance metric of the initial deep neural network by selecting a second deep neural network from the architecture search space, the improving the machine learning task performance metric resulting in a revised deep neural network for a next phase of deep neural network improvement;
program instructions to repeat execution of the optimization method by entering the next phase of chip design improvement using the revised chip design as the initial chip design and by entering the next phase of deep neural network improvement using the revised deep neural network as the initial deep neural network; and
program instructions to, responsive to a combination of the hardware performance metric for a specific chip design and the machine learning task performance metric for a specific deep neural network meeting a convergence criterion, provide the specific chip design and the specific deep neural network for performing the machine learning task.

16. The computer system of claim 15, wherein improving the machine learning task performance metric of the initial deep neural network includes:
satisfying the hardware performance metric for the revised chip design obtained after every n^{th} repetition of the optimization method, where n is an integer within a predefined set of numbers.

17. The computer system of claim 15, wherein:
the first optimizer provides to the second optimizer a revised hardware performance metric when a hardware performance metric value differs by a minimum value from a immediately previous hardware performance metric value; and
improving, by a second optimizer, the machine learning task performance metric of the initial deep neural network is performed while satisfying the revised hardware performance metric.

18. The computer system of claim 15, wherein the convergence criterion requires the hardware performance metric to have a predefined optimal value and/or the machine learning task performance metric to have a predefined optimal value.

19. The computer system of claim 15, wherein:
the convergence criterion requires, before providing the specific chip design:
a specified number of repeated executions of the optimization method; and
either
(a) the hardware performance metric value meets a predefined target value; or
(b) the machine learning task performance metric value meets a predefined target value.

20. The computer system of claim 15, wherein the repeating execution of the optimization method is performed in parallel for multiple initial deep neural networks and corresponding initial chip designs.
